(19) United States
(12) Patent Application Publication
(10) Pub. No.: US 2013/0058597 A1
(43) Pub. Date: Mar. 7, 2013

(54) SLIDING RAIL ASSEMBLY HAVING AN INTERMEDIATE RAIL POSITIONING MECHANISM

(71) Applicants: Te-Jeng CHANG, New Taipei City (TW); Sung-Mu Chiang, New Taipei City (TW)

(72) Inventors: Te-Jeng CHANG, New Taipei City (TW); Sung-Mu Chiang, New Taipei City (TW)

(21) Appl. No.: 13/226,600

(22) Filed: Sep. 7, 2011

(51) Int. Cl. A47B 88/04; F16C 29/10

(52) U.S. Cl. 384/21

(57) ABSTRACT

A sliding rail assembly having a low profile characteristic for use in a server or low profile drawer includes a pressure member at the inner rail thereof, a spring strip at the intermediate rail thereof, two stop blocks at the subsidiary rail thereof and a retaining spring member at the outer rail thereof. When the intermediate rail is extended out of the outer rail, the stop blocks of the subsidiary rail that is connected to the intermediate rail are engaged with the retaining spring member to prohibit retraction of the intermediate rail. When pushing back the intermediate rail, the pressure member forces down the spring strip to move the retaining spring member away from the two stop blocks of the subsidiary rail, allowing the intermediate rail to be received in the outer rail.

### BACKGROUND OF THE INVENTION

1. Field of the Invention

The present invention relates to sliding rail technology and more particularly, to a low profile sliding rail assembly for use in a server or low profile drawer, which automatically locks the extended intermediate rail in position to prohibit the intermediate rail from accidental retraction, and automatically unlocks the intermediate rail when the inner rail is pushed backwards toward the inside of the outer rail.

2. Description of the Related Art

A sliding rail assembly consisting of an inner rail, an intermediate rail and an outer rail generally comprises an intermediate rail positioning mechanism for the positioning of the intermediate rail to avoid retraction of the intermediate rail into the outer rail after the inner rail and the intermediate rail having been extended out. FIG. 1 illustrates a sliding rail assembly 8 with an intermediate rail positioning mechanism 81. This design of intermediate rail positioning mechanism 81 is functional, however, it has a certain height. Thus, the height 80 of the sliding rail assembly 8 does not allow the sliding rail assembly 8 for use in a server or low profile drawer.

Further, Taiwan Patent 1283281 discloses an intermediate rail positioning mechanism for sliding rail assembly entitled “Three-step sliding rail positioning mechanism”. This design sill cannot satisfy the demand for low profile applications.

### SUMMARY OF THE INVENTION

The present invention has been accomplished under the circumstances in view. It is the main object of the present invention to provide a sliding rail assembly, which has a low profile characteristic practical for use in a server or low profile drawer and, which automatically locks the extended intermediate rail in position to prohibit the intermediate rail from accidental retraction, and automatically unlocks the intermediate rail when the inner rail is pushed backwards toward the inside of the outer rail.

It is another object of the present invention to provide a sliding rail assembly, in which the pressure member at the inner rail, the spring strip at the intermediate rail, the slot and stop blocks at the subsidiary rail and the retaining spring member at the outer rail are simple components that are easy and inexpensive to make, and therefore the sliding rail assembly has the characteristics of low manufacturing cost and high product competitiveness.

To achieve these and other objects of the present invention, a sliding rail assembly consists of an inner rail, a first slide, an intermediate rail, a subsidiary rail, a second slide, and an outer rail. The inner rail comprises a pressure member having an actuation portion protruding toward the intermediate rail. The intermediate rail comprises a slot cut through the base wall thereof, and a spring strip. The spring strip comprises a mounting portion affixed to the base wall of the intermediate rail, a spring arm extended from the mounting portion through the slot of the intermediate rail toward the inner rail and pressable by the actuation portion of the pressure member, and a press portion extended from the spring arm remote from the mounting portion. The subsidiary rail comprises a slot cut through the base wall thereof corresponding to the slot of the intermediate rail, and two stop blocks respectively disposed at two opposite lateral sides of the slot. The outer rail comprises a retaining spring member fixedly fastened to the front end of the base wall thereof. The retaining spring comprising a mounting portion affixed to the base wall of the outer rail, a spring arm obliquely extended from the mounting portion, an end piece curved from one end of the spring arm remove from the mounting portion, and two retaining lugs respectively extended from two opposite lateral sides of the end piece for engagement with the two stop blocks at the base wall of the subsidiary rail. The end piece of the retaining spring member is pressable by the press portion of the spring strip to disengage the two retaining lugs from the two stop blocks at the base wall of the subsidiary rail.

### BRIEF DESCRIPTION OF THE DRAWING

FIG. 1 is an elevational view of a sliding rail assembly with an intermediate rail positioning mechanism according to the prior art.

FIG. 2 is an elevational view of a sliding rail assembly in accordance with the present invention, illustrating the inner rail and the intermediate rail extended out of the outer rail.

FIG. 3 is another elevational view of the sliding rail assembly in accordance with the present invention, illustrating the intermediate rail extended out of the outer rail and the inner rail received in the intermediate rail.

FIG. 4 is still another elevational view of the sliding rail assembly in accordance with the present invention, illustrating the inner rail and the intermediate rail received in the outer rail.

FIG. 5 is an exploded view of the sliding rail assembly in accordance with the present invention.

FIG. 6 is an elevational view, in an enlarged scale, of the inner rail of the sliding rail assembly in accordance with the present invention.

FIG. 7 is an elevational view, in an enlarged scale, of the intermediate rail and subsidiary rail of the sliding rail assembly in accordance with the present invention.

FIG. 8 is an exploded view, in an enlarged scale, of a part of the present invention, illustrating the relationship between the intermediate rail and the subsidiary rail.

FIG. 9 is an elevational view, in an enlarged scale, of the outer rail of the sliding rail assembly in accordance with the present invention.

FIG. 10 is an exploded view, in an enlarged scale, of a part of the present invention, illustrating the structure of the outer rail.

FIG. 11 is a sectional view, in an enlarged scale, of a part of the present invention, illustrating the inner rail and the intermediate rail extended out of the outer rail and the subsidiary rail retained in position by the retaining spring member.

FIG. 12 is an enlarged view of a part of the present invention, illustrating the two stop blocks at the base wall of the subsidiary rail engaged with the two retaining lugs of the end piece of the retaining spring member.

FIG. 13 is a sectional view, in an enlarged scale, of a part of the present invention, illustrating the pressure member at the inner rail pressed on the spring strip at the intermediate rail and the two stop blocks at the base wall of the subsidiary rail disengaged from the two retaining lugs of the end piece of the retaining spring member.

FIG. 14 corresponds to FIG. 13, illustrating continuous movement of the inner rail toward the inside of the outer rail after disengagement of the two stop blocks at the base wall of the subsidiary rail from the two retaining lugs of the end piece of the retaining spring member.

FIG. 15 is an elevational view of the spring strip according to the present invention.

FIG. 16 is an elevational view of the retaining spring member according to the present invention.

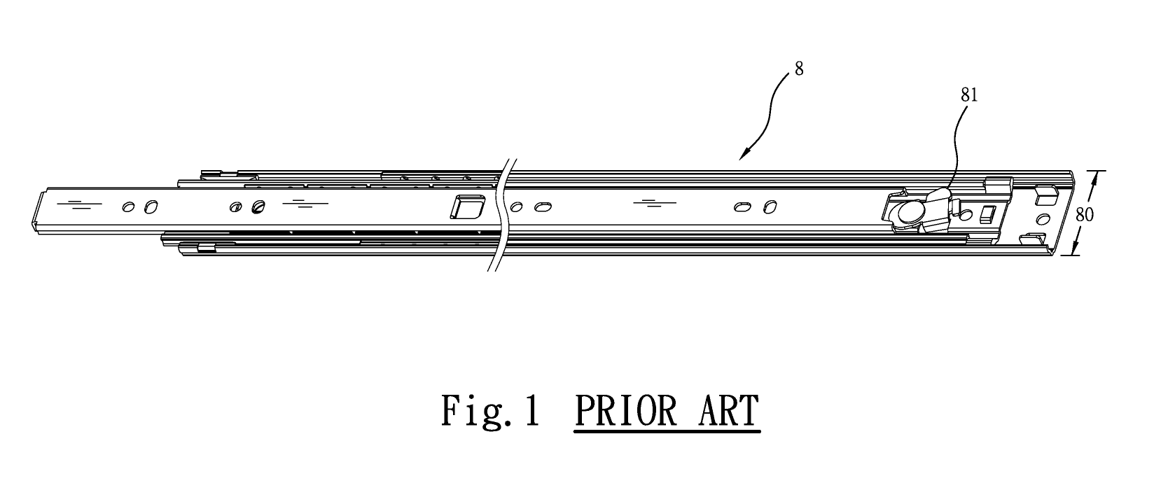

### DETAILED DESCRIPTION OF THE INVENTION

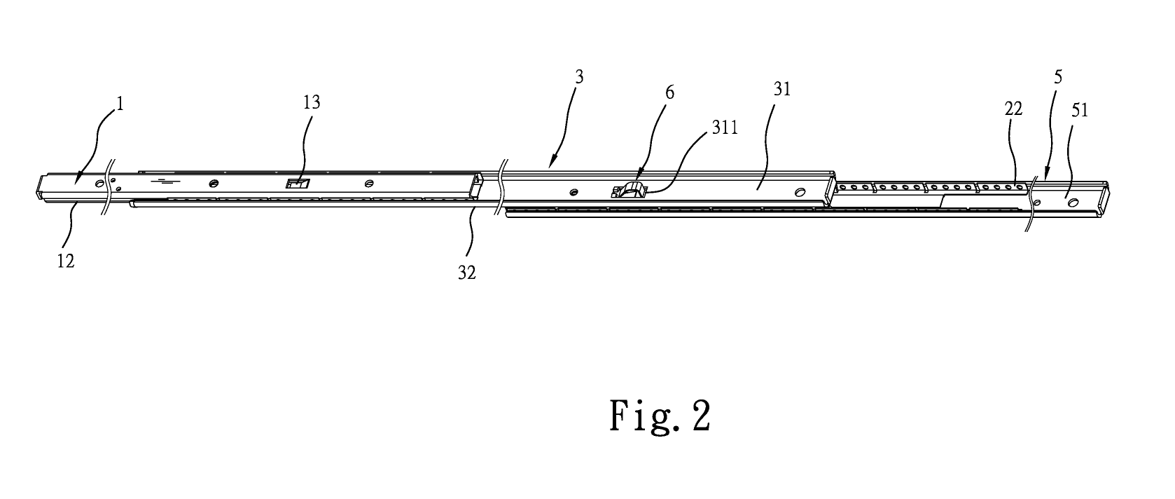

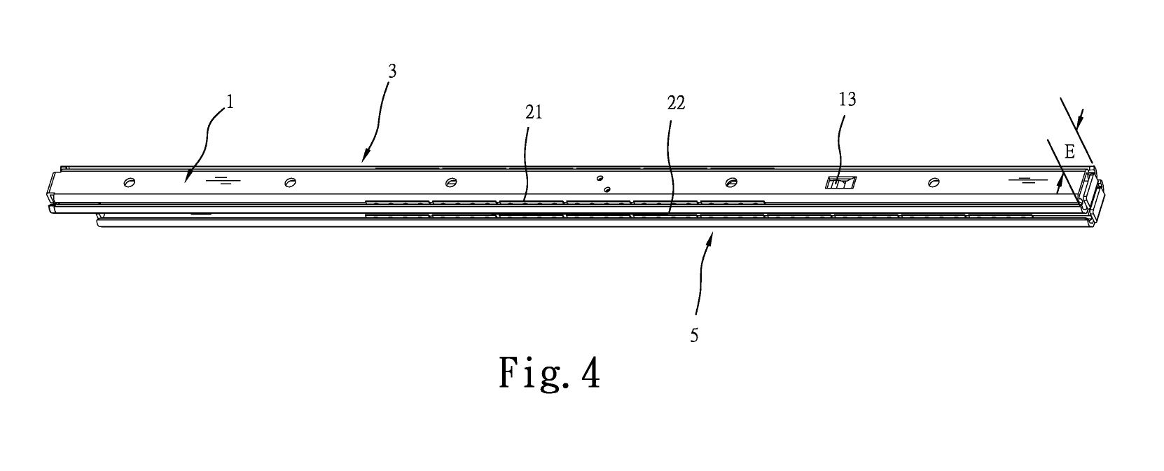

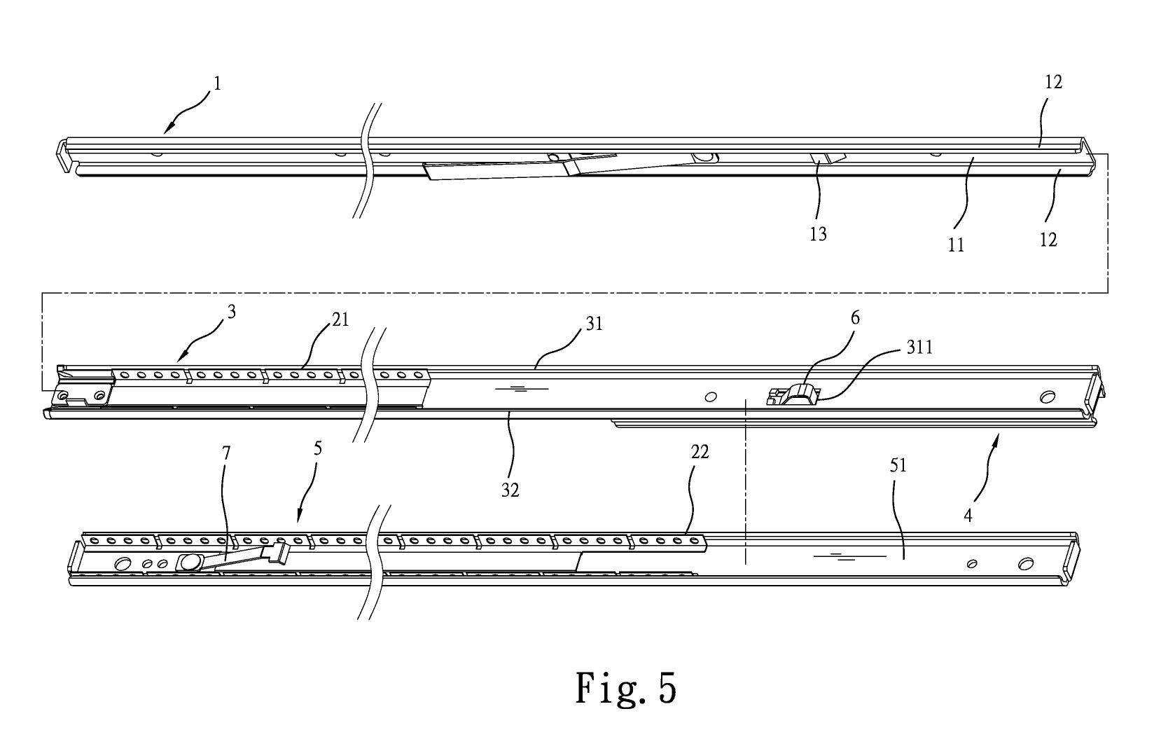

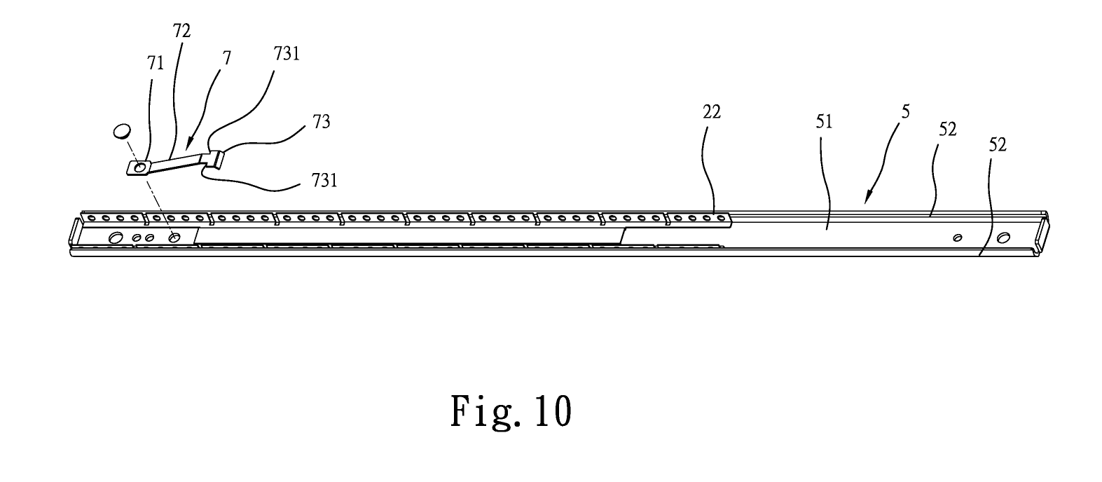

Referring to FIGS. 2-16, a sliding rail assembly having an intermediate rail positioning structure in accordance with the present invention is shown comprising:

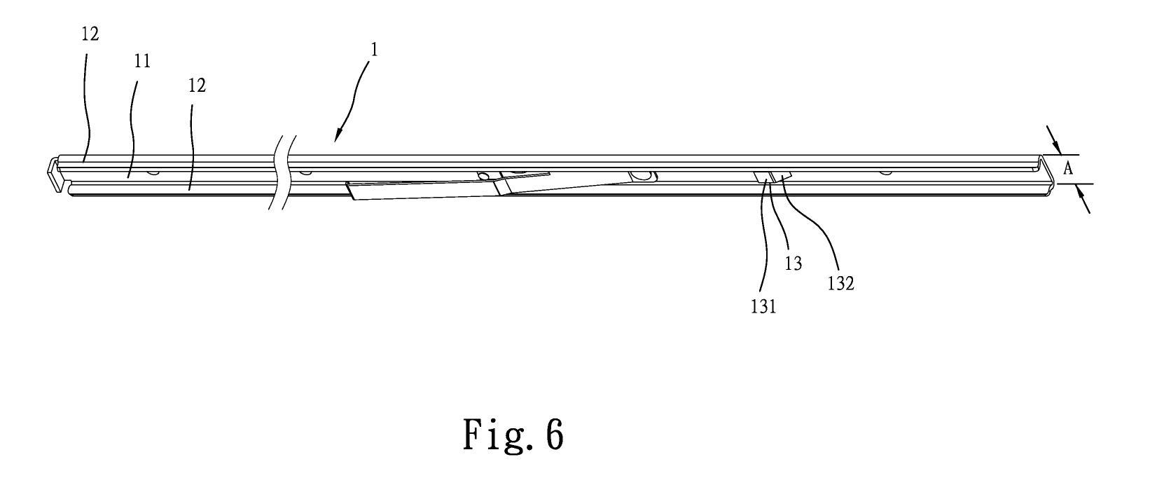

an inner rail 1 having a base wall 11 and two opposing sidewalls 12 at two opposite lateral sides of the base wall 11 (see FIG. 6);

a first slide 21 coupled between the inner rail 1 and an intermediate rail 3;

an intermediate rail 3 having a base wall 31 and two opposing sidewalls 32 at two opposite lateral sides of the base wall 31;

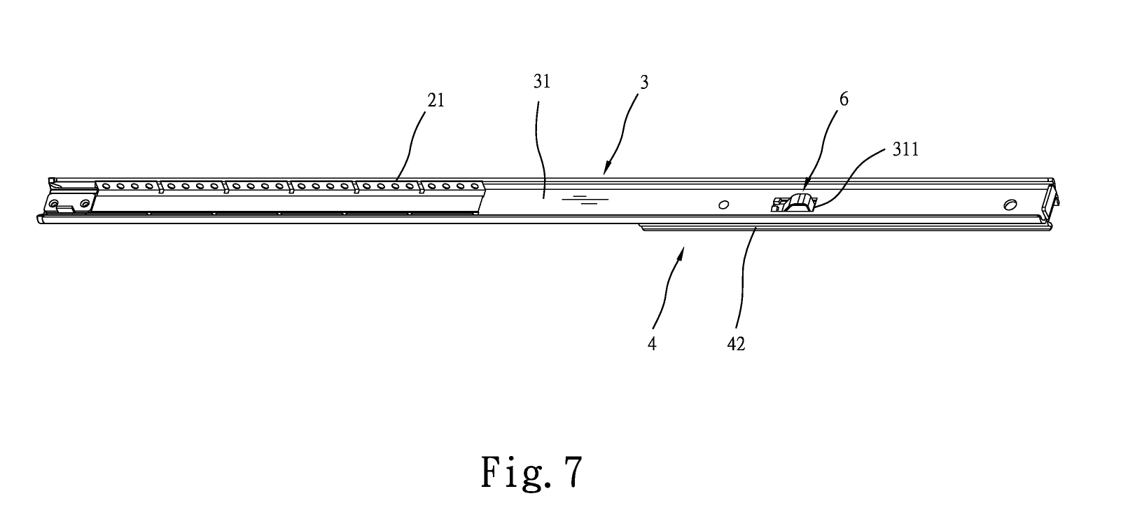

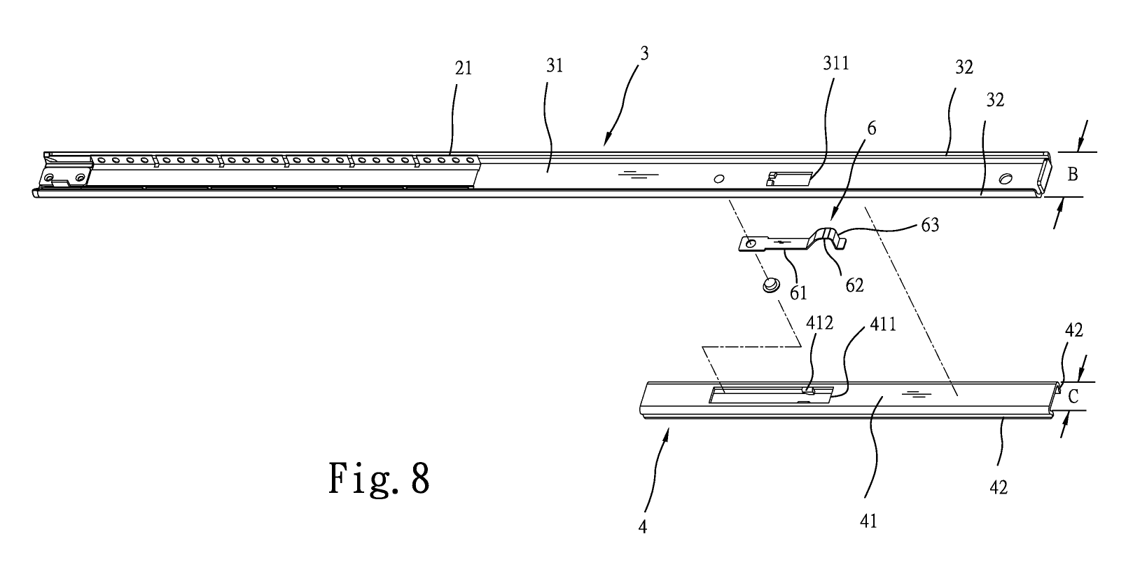

a subsidiary rail 4 (see FIGS. 7 and 8) having a base wall 41 fastened to the rear end of the base wall 31 of the intermediate rail 3 by riveting or any other fastening technique and two opposing sidewalls 42 disposed at two opposite lateral sides of the base wall 41 and slidably coupled to an outer rail 5;

a second slide 22 coupled between the subsidiary rail 4 and an outer rail 5; and

an outer rail 5 having a base wall 51 and two opposing sidewalls 52 at two opposite lateral sides of the base wall 51;

wherein:

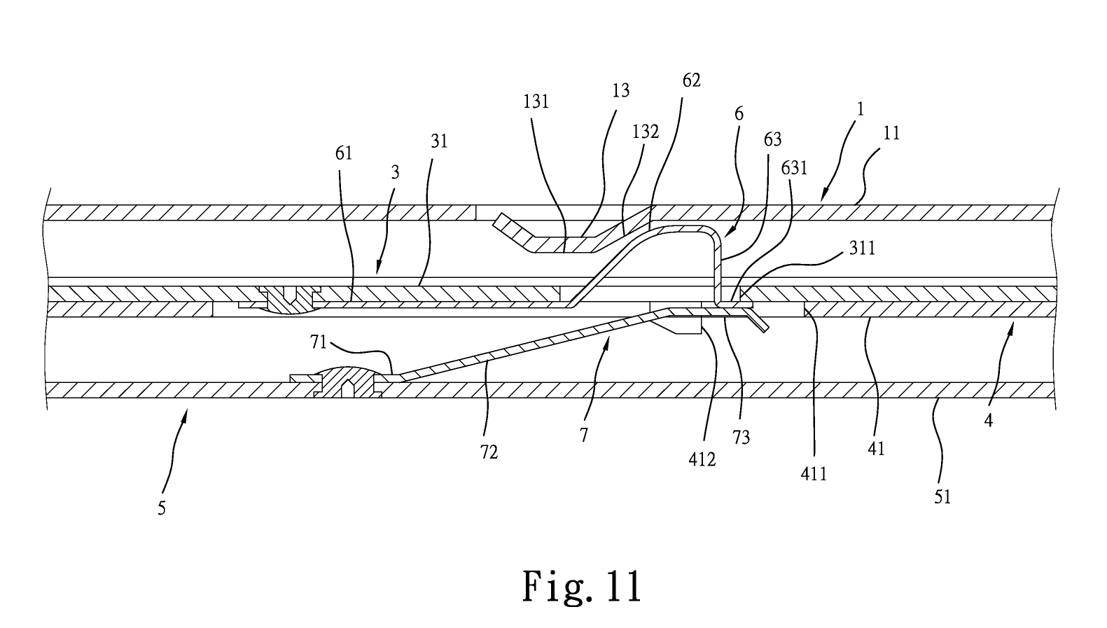

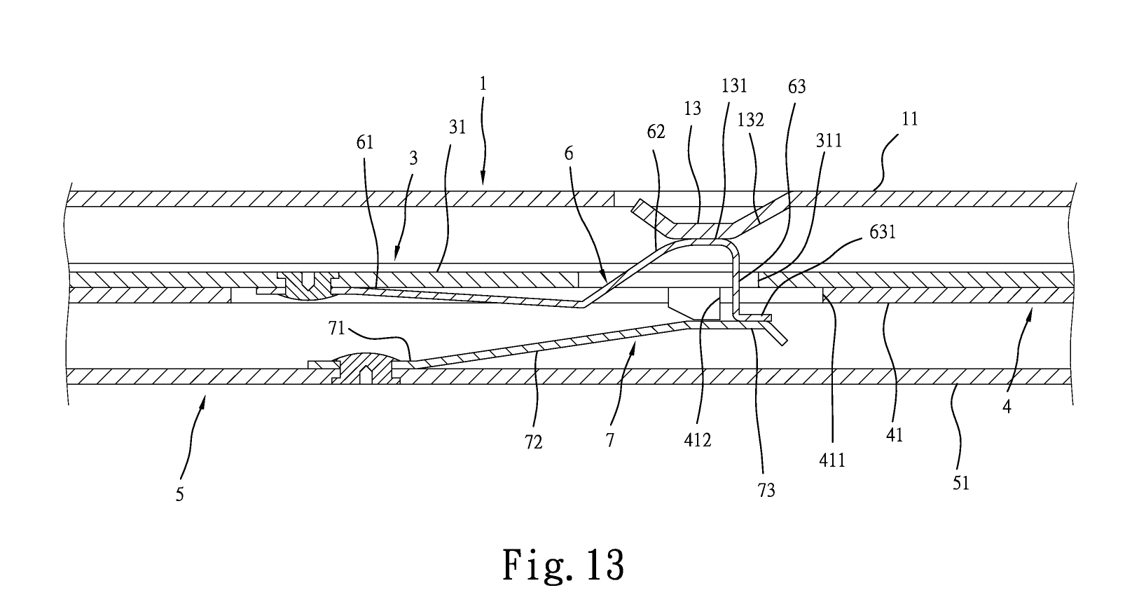

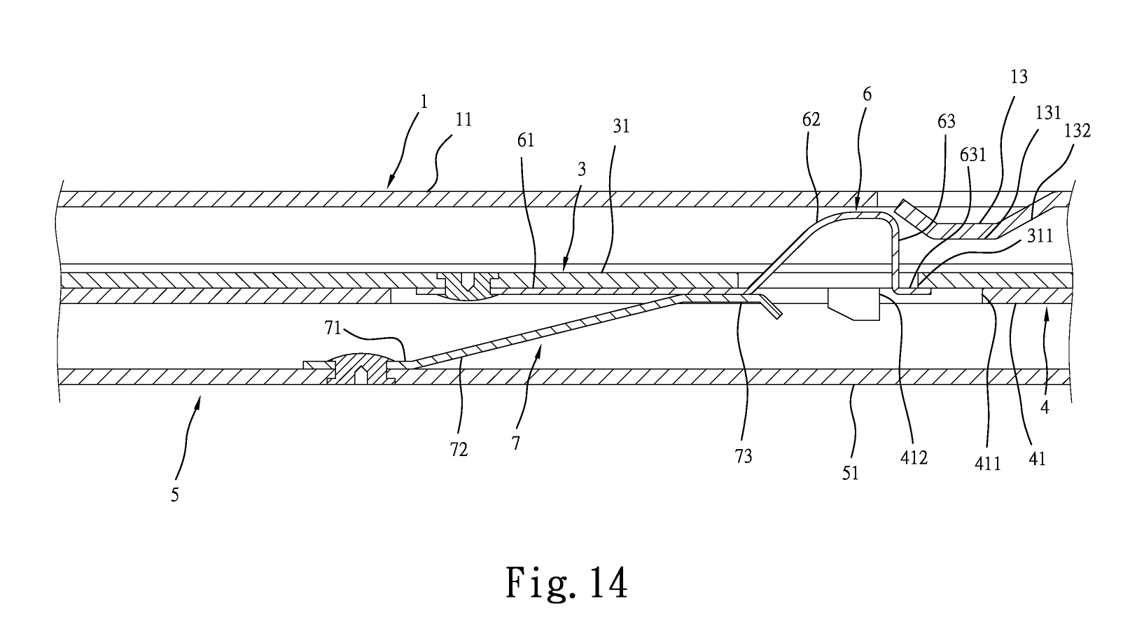

the inner rail 1 comprises a pressure member 13 at the rear end thereof (see FIG. 6, FIG. 11, FIG. 13 and FIG. 14), which comprises an actuation portion 131 protruding toward the intermediate rail 3, a guide portion 132 connected between the base wall 11 and the actuation portion 131 and curvedly extended from the actuation portion 131 in direction toward the base wall 11;

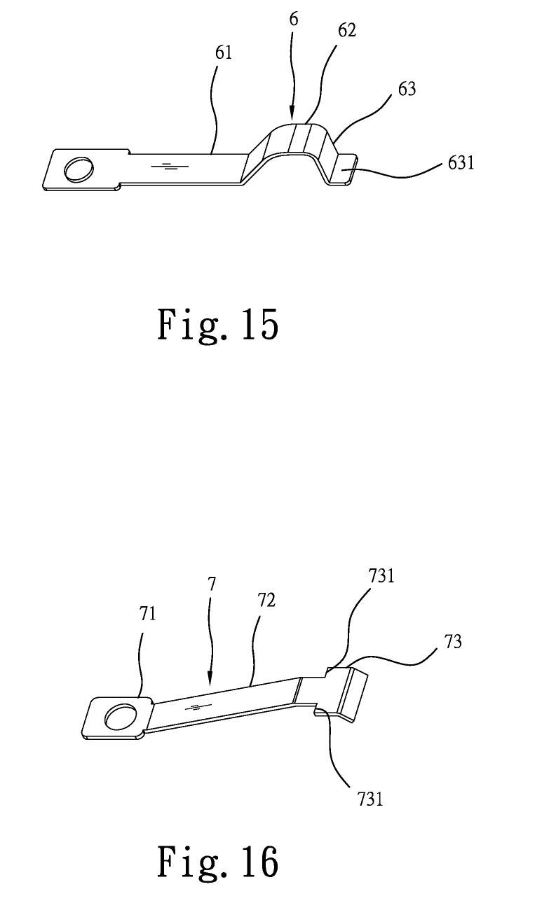

the intermediate rail 3 comprises a slot 311 cut through the base wall 31 near the rear end thereof (see FIG. 8, FIG. 11, FIG. 13 and FIG. 14), and a spring strip 6, which comprises a mounting portion 61 affixed to the base wall 31 of the intermediate rail 3 (see FIG. 8, FIG. 11, FIG. 13, FIG. 14 and FIG. 15), a spring arm 62 extended from the mounting portion 61 through the slot 311 toward the inner rail 1 and pressable by the actuation portion 131 of the pressure member 13, and a press portion 63 extended from one end of the spring arm 62 remote from the mounting portion 61 toward the outer rail 5;

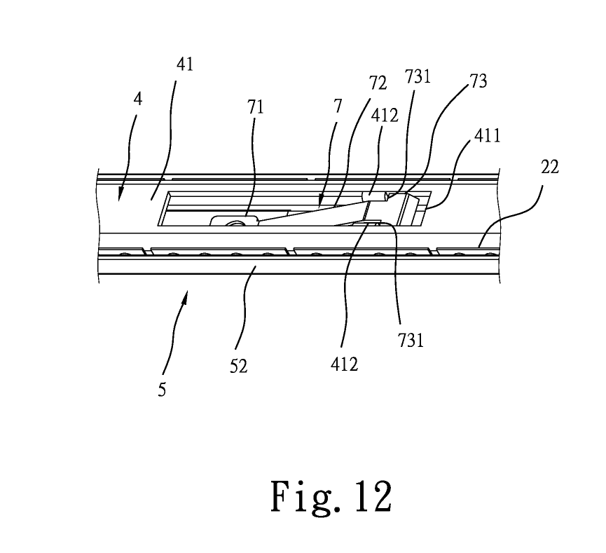

the subsidiary rail 4 (see FIG. 8 and FIG. 12) comprises a slot 411 cut through the base wall 41 near its front end corresponding to the slot 311 of the intermediate rail 3 (see also FIG. 11, FIG. 13 and FIG. 14), and two stop blocks 412 respectively disposed at two opposite lateral sides of the slot 411 and projecting toward the outer rail 5 (see FIG. 12 and FIG. 13);

the outer rail 5 comprises a retaining spring member 7 fixedly fastened to the front end of the base wall 51 thereof by riveting, welding or any of a variety of other fastening techniques, which comprises a mounting portion 71 affixed to the base wall 51, a spring arm 72 obliquely extended from the mounting portion 71, an end piece 73 curved from one end of the spring arm 72 remove from the mounting portion 71, and two retaining lugs 731 respectively extended from two opposite lateral sides of the end piece 73 (see FIG. 12 and FIG. 16) for engagement with the two stop blocks 412 at the base wall 41 of the subsidiary rail 4.

Further, the end piece 73 of the retaining spring member 7 is pressable by the press portion 63 of the spring strip 6 to disengage the two retaining lugs 731 from the two stop blocks 412 at the base wall 41 of the subsidiary rail 4.

Further, the pressure member 13 can be formed of a part of the base wall 11 of the inner rail 1 by a stamping technique. Alternatively, the pressure member 13 can be an independent member separately made and then affixed to the rear end of the base wall 11 of the inner rail 1.

Thus, when the inner rail 1 and the intermediate rail 3 are fully extended out, the two stop blocks 412 at the base wall 41 of the subsidiary rail 4 are engaged with the two retaining lugs 731 of the end piece 73 of the retaining spring member 7 (see FIG. 11 and FIG. 12), securing the intermediate rail 3 firmly in the extended position and prohibiting the intermediate rail 3 from retraction. When the user is going to push the intermediate rail 3 back into the inside of the outer rail 5, push the inner rail 1 backwards directly. When the actuation portion 131 of the pressure member 13 reaches the position right above the spring strip 6 at the intermediate rail 3 during backward movement of the inner rail 1 (see FIG. 13), the actuation portion 131 of the pressure member 13 forces down the bottom 631 of the press portion 63 of the spring strip 6 to move the two retaining lugs 731 of the end piece 73 of the retaining spring member 7 away from the two stop blocks 412 at the base wall 41 of the subsidiary rail 4, allowing the subsidiary rail 4 to be moved with the intermediately rail 3 continuously toward the inside of the outer rail 5 to the received position (see FIG. 14).

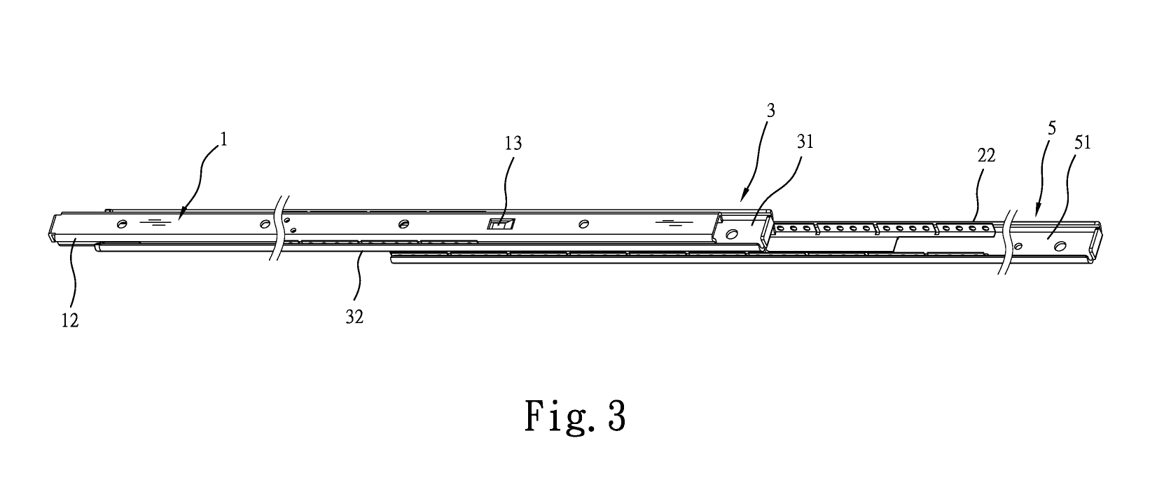

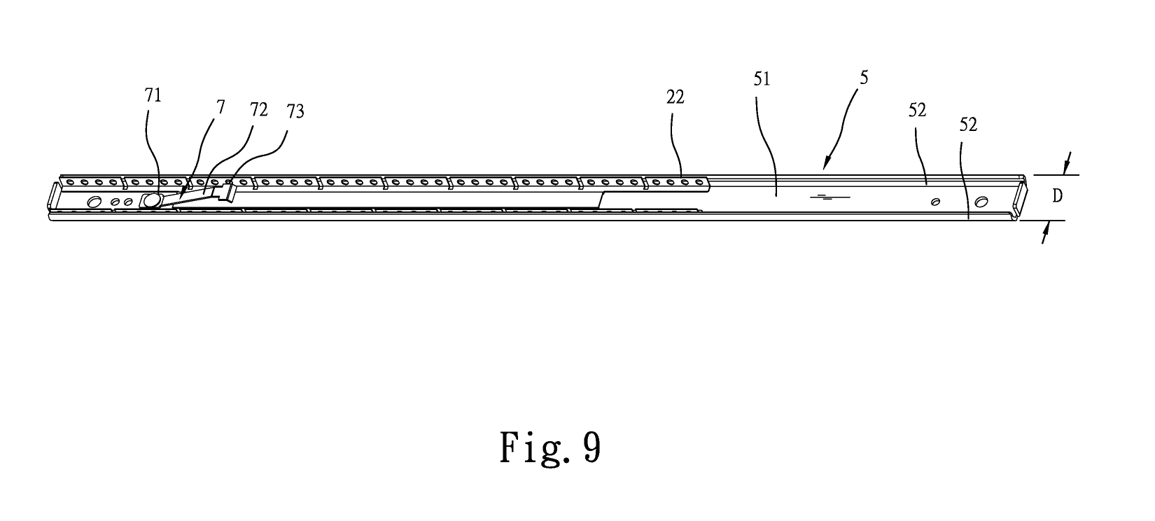

In conclusion, the invention provides a sliding rail assembly having an intermediate rail positioning structure, which has advantages and features as follows:
1. The pressure member 13, the spring strip 6, the stop blocks 412 and the retaining spring member 7 are respectively suspending in the inner rail 1, the intermediate rail 3, the subsidiary rail 4 and the outer rail 5 without increasing the height of the sliding rail assembly, the heights A;B;C;D of the inner rail 1, the intermediate rail 3, the subsidiary rail 4 and the outer rail 5 are minimized (see FIG. 6, FIG. 8 and FIG. 9), and therefore the height E of the sliding rail assembly is minimized (see FIG. 3) and suitable for use in a server or low profile drawer, i.e., the invention has industrial value.
2. The pressure member 13 at the inner rail 1, the spring strip 6 at the intermediate rail 3, the slot 411 and stop blocks 412 at the subsidiary rail 4 and the retaining spring member 7 at the outer rail 5 are simple components that are easy and inexpensive to make, and therefore the sliding rail assembly has the characteristics of low manufacturing cost and high product competitiveness.

1. A sliding rail assembly, comprising:
an inner rail comprising a base wall and two opposing sidewalls at two opposite lateral sides of the base wall;
an intermediate rail comprising a base wall and two opposing sidewalls at two opposite lateral sides of the base wall;
a first slide coupled between the inner rail and the intermediate rail;
a subsidiary rail comprising a base wall fastened to a rear end of the base wall of said intermediate rail and two opposing sidewalls disposed at two opposite lateral sides of the base wall of said subsidiary rail;
an outer rail comprising a base wall and two opposing sidewalls at two opposite lateral sides of the base wall and slidably coupled to the subsidiary rail; and
a second slide coupled between said subsidiary rail and the outer rail;
wherein:
said inner rail comprises a pressure member at a rear end thereof, said pressure member comprising an actuation portion protruding toward said intermediate rail;
said intermediate rail comprises a slot cut through the base wall thereof near the rear end, and a spring strip, said spring strip comprising a mounting portion affixed to the base wall of said intermediate rail, a spring arm extended from the mounting portion of said spring strip through the slot of said intermediate rail toward said inner rail and pressable by the actuation portion of said pressure member, and a press portion extended from one end of the spring arm of said spring strip remote from the mounting portion of said spring strip toward said outer rail;
said subsidiary rail comprises a slot cut through the base wall thereof near a front end corresponding to the slot of said intermediate rail, and two stop blocks respectively disposed at two opposite lateral sides of the slot of said subsidiary rail and projecting toward said outer rail; and
said outer rail comprises a retaining spring member fixedly fastened to a front end of the base wall thereof, said retaining spring comprising a mounting portion affixed to the base wall of said outer rail, a spring arm obliquely extended from the mounting portion of said retaining spring member, an end piece curved from one end of the spring arm of said retaining spring member distal from the mounting portion of said retaining spring member, and two retaining lugs respectively extended from two opposite lateral sides of said end piece for engagement with the two stop blocks at the base wall of said subsidiary rail, the end piece of said retaining spring member being pressable by the press portion of said spring strip to disengage said two retaining lugs from the two stop blocks at the base wall of said subsidiary rail and wherein, when the inner rail and the intermediate rail are fully extended out, the two stop blocks at the base wall of the subsidiary rail are engaged with the two retaining lugs of the end piece of the retaining spring member, thereby securing the intermediate rail in the extended position and inhibiting the intermediate rail from retraction and, upon application of inward force on the intermediate rail back into the inside of the outer rail, the inner rail is pushed backwards such that the actuation portion of the pressure member reaches a position above the spring strip at the intermediate rail during backward movement of the inner rail, and such that the actuation portion of the pressure member forces down the bottom of the press portion of the spring strip to move the two retaining lugs of the end piece of the retaining spring member away from the two stop blocks at the base wall of the subsidiary rail, thereby allowing the subsidiary rail to be moved with the intermediately rail toward the inside of the outer rail to the received position.

2. The sliding rail assembly as claimed in claim 1, wherein said pressure member further comprises a guide portion obliquely connected between the base wall of said inner rail and said actuation portion.

3. The sliding rail assembly as claimed in claim 2, wherein said guide portion extends from said actuation portion toward the base wall of said inner rail.
